(19) United States
(12) Patent Application Publication
(10) Pub. No.: US 2010/0075340 A1
(43) Pub. Date: Mar. 25, 2010

(54) Electrical Detection Of Biomarkers Using Bioactivated Microfluidic Channels

(76) Inventors: Mehdi Javanmard, Sunnyvale, CA (US); Mostafa Ronaghi, Los Altos Hills, CA (US); Ron W. Davis, Palo Alto, CA (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 12/563,452

(22) Filed: Sep. 21, 2009

Related U.S. Application Data
(60) Provisional application No. 61/098,825, filed on Sep. 22, 2008.

(51) Int. Cl. G01N 33/53; G01N 33/00; G01N 33/566; G01N 33/543; C12M 1/34; G01N 30/96; G01R 27/08

(52) U.S. Cl. 435/7.1; 436/86; 436/94; 436/501; 436/518; 435/287.1; 422/69; 324/694

(57) ABSTRACT

The present disclosure encompasses the manufacture and use of rapid and inexpensive electrical biosensors comprising microelectrodes in a micro-channel. The devices of the disclosure can be used to detect and quantify target cells, protein biomarkers, and nucleic acid biomarkers, and the like, by measuring instantaneous changes in ionic impedance. The micro-channel devices of the disclosure are also suitable for the detection of target protein and oligonucleotide, and small molecule target biomarkers using protein-functionalized micro-channels for the rapid electrical detection and quantification of any type of target protein biomarker in a sample. The biochip microfluidic devices may be combined with an integrated circuitry into a portable handheld device for multiplex high throughput analysis using an array of micro-channels for probing clinically relevant samples, such as the human serum, for multiple protein and nucleic acid biomarkers for disease diagnosis, and the detection of potentially pathogenic organisms.

### CROSS-REFERENCE TO RELATED APPLICATIONS

This application claims priority to U.S. Provisional Patent Application Ser. No. 61/098,825, entitled “ELECTRICAL DETECTION OF BIOMARKERS USING BIOACTIVATED MICROFLUIDIC CHANNELS” filed on Sep. 22, 2008, the entirety of which is hereby incorporated by reference.

### TECHNICAL FIELD

The present disclosure is generally related to microfluidic devices for the detection of particles and proteins by detecting impedance changes in a micro-channel.

### BACKGROUND

Disease diagnosis at an early stage requires the availability of inexpensive platforms which can accurately and rapidly analyze a wide panel of biomarkers. Current techniques for biomarker detection include culture enrichment for detection of target cells, ELISA for protein analysis, and DNA microarrays for nucleic acid biomarkers. These expensive and time consuming methods can take several days.

The detection of various types of target cells at low concentrations can provide valuable information necessary for accurate disease diagnosis at an early stage. The detection of various types of bacterial cells in clinical samples is also of use in early disease diagnosis. Another application where recognition of target cells at low concentrations is necessary is the detection of potentially pathogenic bacteria in food. Currently the techniques used for detection of pathogens involve expensive and time consuming microbiological methods such as culture enrichment and plating techniques, which can take several days. E. coli 0157:H7, for example, is a strain of pathogenic bacteria that does not ferment sorbitol rapidly as compared to other strains of E. coli bacteria. Based on this quality, a selective media was developed, where a change in the pH will be seen where E. coli 0157:H7 is not present. The drawback of such a technique is that this process has to be performed on each and every colony in the sample, and each test takes between 24-48 hours due to the required incubation time.

The detection and quantifying of proteins in a patient's blood or serum can provide valuable information with regard to disease diagnosis such as cancer, and viral or bacterial detection. The current technology used in the clinical setting for quantifying and detecting protein biomarkers is the Sandwich Enzyme Linked ImmunoSorbent Assay (ELISA). The process is performed by immobilizing probe antibodies that are complementary to the target protein biomarker, on the surface of a 96-well plate. The test sample is contacted with a functionalized surface, allowing target protein biomarkers to be captured by the probe antibodies. To add a second level of specificity, a secondary probe molecule attached to a reporter molecule (typically a fluorescent, luminescent, or radioactive label) is then injected over the surface, to be captured by a second epitope resident on the surface of the target protein, thus forming a sandwich complex between the primary antibody, the target protein, and the secondary antibody. The signal that is produced by the reporter molecule is then recorded by the optical scanning detectors. The intensity of the signal is proportional to the quantity of the target protein. However, such protein detection assays are expensive and time consuming for several reasons. The lengthy incubation times (several hours) and also the reagent preparation times resulting from the use of labels make the process time consuming.

By analyzing a patient's DNA for various genes, mutations, or single nucleotide polymorphisms, valuable information can be gained determining whether that patient is susceptible to certain types of diseases in the future, thus allowing preventative measures to be applied in advance. The most common platform for detecting DNA hybridization is the DNA microarray. These are essentially arrays of spots that are ordered with probe DNA molecules used for measuring the quantity of target nucleic acid molecules. Each spot is functionalized with a different nucleic acid sequence, and is intended to hybridize with its' complementary target strand which is labeled with a fluorescent tag. The chip is then washed off to remove the non-specifically bound molecules. The spots that have hybridized will produce enough fluorescent signal to be readable by the optical detectors. Although DNA microarrays are the most widely used platform for analyzing gene expression, they have several disadvantages. The method requires a long incubation time for sufficient target DNA molecules to hybridize to produce enough optical signal to be readable by the optical detectors, and there is a high reagent cost and reagent preparation time.

### SUMMARY

The present disclosure encompasses the manufacture and use of rapid and inexpensive electrical biosensors, the biosensors comprising microelectrodes in a micro-channel. The devices of the disclosure can be used to detect and quantify target cells, protein biomarkers, and nucleic acid biomarkers, and the like by measuring instantaneous changes in ionic impedance.

The micro-channel devices of the disclosure are also suitable for the detection of target protein, oligonucleotide, and small molecule biomarkers using functionalized micro-channels for the rapid electrical detection and quantification of any type of target biomarker in a sample. For instance, detection of anti-hCG antibody, at a concentration of 1 ng/ml is possible in less than one hour. The platform also has the ability to electrically detect the hybridization of DNA molecules within seconds, which is four orders of magnitude faster than the conventional DNA microarray technologies.

The biochip devices of the present disclosure may be combined with an integrated circuitry into a portable handheld device for multiplex high throughput analysis using an array of micro-channels for probing clinically relevant samples, such as the human serum, for multiple protein and nucleic acid biomarkers for disease diagnosis, and the detection of potentially pathogenic organisms.

One aspect of the disclosure, therefore, provides methods for selectively detecting a particulate target comprising: (a) determining a first electrical impedance of a first fluid disposed in a micro-channel, wherein the micro-channel comprises a surface having a first target-specific binding agent bound thereto, a first electrode and a second electrode, wherein the first and second electrodes are configured to deliver an electrical current through a fluid disposed in the micro-channel; (b) delivering to the micro-channel a test fluid suspected of comprising a target to be detected, wherein the target is a particulate target or a non-particulate target bound to a particle; (c) washing the micro channel with a second fluid, wherein the first and the second fluids have the same composition; and (d) determining a second electrical impedance of the second fluid disposed in the micro-channel, whereby a difference between the first impedance and the second impedance indicates that a particulate target or a non-particulate target bound to a particle is present in the test fluid.

Another aspect of the disclosure provides microfluidic devices for detecting a target, comprising: a micro-channel defined by a channel in an polymeric overlay, wherein the polymeric overlay is bonded to a substrate, and wherein the micro-channel is further defined by a surface of the substrate; a first electrode and a second electrode, wherein each of the first and the second electrodes extends into the micro-channel and are configured for passing of an electrical current through the micro-channel; a fluid entry port and a fluid exit port, the entry and exit ports each communicating with the micro-channel.

### BRIEF DESCRIPTION OF THE DRAWINGS

Further aspects of the present disclosure will be more readily appreciated upon review of the detailed description of its various embodiments, described below, when taken in conjunction with the accompanying drawings.

FIG. 1 illustrates a longitudinal sectional schematic of an embodiment of a gated micro-channel device 100 according to the disclosure. (Bottom inset): Current between electrodes 20 and 40 during bead or cell capture.

FIG. 2 schematically illustrates the process for fabrication of an embodiment of a micro-channel device.

FIG. 3A illustrates a schematic of an embodiment of a micro-channel device 100 according to the disclosure.

FIG. 3B is a photograph of a single chip containing three different channels with integrated electrodes.

FIG. 3C shows a top view of an embodiment of a 50 μm deep micro-channel device 100 according to the disclosure integrated with electrodes labeled A, B, and C.

FIG. 3D shows a top view of an embodiment of a 10 μm deep channel.

FIG. 3E illustrates schematically a system incorporating a micro-channel device 100 according to the disclosure connected to a power source 70, amplification circuitry 80, and a data acquisition device 90.

FIG. 4A illustrates a longitudinal sectional of gated micro-channel 10 with electrodes labeled 20, 30, and 40. Targeted cells 50 bind to the antibodies 60 that are immobilized on the gold electrode 30. (Bottom inset) The bottom inset shows the prediction of current between electrodes 20 and 40 after injection of cells.

FIG. 4B is a graph illustrating the magnitude of ionic impedance across two electrodes of the micro-channel device. The impedance levels off above 10 kHz indicating the solution resistance is dominant at these frequencies. The binding of yeast cells to Concanavalin A on the electrode results in an increase in ionic impedance at frequencies above 10 kHz.

FIG. 4C is an optical micrograph of electrodes before (b), and after (c) yeast cells bind to electrodes.

FIG. 4D illustrates impedance at 29.8 kHz vs. time. The impedance jump at t=59 secs (A) was due to yeast binding, (B) impedance vs. time where the impedance drop at t=155 secs was due to yeast release, and (C) shows an optical micrograph of gold electrodes A and B. Yeast clump is bound onto electrodes.

FIG. 4E shows (A) an optical micrograph of gold electrode after yeast binding has occurred. (B) is a graph showing the impedance at 29.8 kHz vs. time. The impedance jump at t=55 secs was due to yeast binding.

FIG. 4F illustrates (A) an optical micrograph of yeast cells accumulating in the channel at t=75 secs; (B) an optical micrograph of yeast cells accumulating in the channel at t=130 secs; and (C) is a graph plotting the impedance at 29.8 kHz vs. time. The impedance increased steadily as cells accumulated in micro-channel. Release of cells resulted in an impedance drop at t=160 secs. The same cycle is repeated until t=220 secs. No cells across electrodes after t=220 secs.

FIG. 5A shows a longitudinal sectional schematic of an embodiment of a gated micro-channel 10 with electrodes 20, 30, and 40. The functionalized beads 50 specifically bind to the protein receptors 60 which are immobilized on the gold electrode 30 located between electrodes 20, 40. (Bottom inset): Current between electrodes 20 and 40 during bead capture.

FIG. 5B is an optical micrograph of electrodes 20 and 30 in a micro-channel 10 at t>5 secs after a lactoperoxidase coated CPG bead binds to electrode 30. Electrode 40 is not shown.

FIG. 5C is a graph illustrating representative data measured in an embodiment of a micro-channel gated micro-channel device 100. The instantaneous increase in impedance at t=7 secs corresponds to a lactoperoxidase coated CPG bead binding onto the active region of the device as shown in FIG. 5B. Noise level is 0.23% of the baseline impedance.

FIG. 5D is a graph illustrating representative data measured for human chorionic gonadotropin (hCG) and anti-hCG interactions. The instantaneous increase in impedance at t=27 secs corresponds to hCG coated latex beads binding onto the active region of the device. The peak at t=16 secs correspond to several beads passing across the sensor without getting capture. The sharp spike at t=27 secs corresponds to many beads passing across the sensor with only some of them getting captured, and then leveling off at approximately 76 kΩ.

FIG. 5E illustrates the results of microsphere binding strength measured under a variety of conditions.

FIG. 6 illustrates a scheme of the particulate analyte assay method. (a) micron sized bead; (b) bead coated with receptors; and then (c) immersed in a multi-analyte solution; (d) beads were labeled with targeted biomarkers in a phosphate buffer saline (PBS) solution (138 mM NaCl, 2.4 mM KCl) at pH 7.4, loaded into the channel and allowed to bind to the secondary receptor molecules immobilized on the gold electrode; (e) (Top plot) sandwich assay at the channel surface. (Bottom plot) prediction of resistance after injection of beads; (f) the channel is flushed, causing the unbound beads to be removed from the channel. The magnitude of the resistance change is proportional to the target biomarker concentration.

FIG. 7 is an optical image of beads in channel as a large bead is captured on electrode 30 at t=9 secs. After the large bead is captured several beads pile up in the channel behind the blockage.

FIG. 8A is a graph illustrating the percentage of beads remaining attached in the micro-channel after incubation, as measured optically, at different concentrations of target protein biomarker and establishing dynamic range of 3 orders in magnitude. A detection limit of 1 ng/ml has been demonstrated. Inset: optical image of beads in channel before washing, and after washing for the case where no target biomarker was present.

FIG. 8B is a graph illustrating the percentage decrease in ionic impedance across the channel as a function of protein biomarker concentration with standard error bars. Detection limit of 1 ng/ml and dynamic range of three orders of magnitude demonstrated. Inset: Percentage change in resistance as a function of time.

FIG. 9A illustrates a longitudinal sectional of an embodiment of a micro-channel device activated with oligonucleotide probes. Target DNA strands are immobilized on the surface of polystyrene beads that are injected into the micro-channel 10.

FIG. 9B is a graph illustrating that hybridization of the DNA strands causes capture of beads and the resistance to increases. At t=9 secs, as the beads pass through the channel and are trapped onto electrode B, as shown in FIG. 9A, resulting in an increase in the channel resistance.

FIG. 10 illustrates an embodiment of the micro-channel device 100 having multiple micro-channels fabricated onto a single chip. If each of the channels is functionalized with a different probe molecule, this embodiment of the chip can be used for probing a solution for various types of cells or biomarkers.

FIG. 11 illustrates an embodiment of the micro-channel device 100 having multiple sets of electrodes integrated into a bioactivated micro-channel to maximize the cell capture rate, and also to minimize the error bars for quantification of protein biomarkers.

FIG. 12 is a graphical illustration of the average flow rate required to pull off all of the beads attached to the base of the channel. First column: the target and probe DNA hybridized and a flow rate greater than 350 nl/min was required to pull the beads off. Second column: the target DNA and the probe DNA were mismatched, thus a negligible flow rate was sufficient to pull off the beads. Third column: there was no DNA on the beads or on the channel surface, and again a negligible flow rate was sufficient to pull off the beads. To minimize the false positive signals due to beads non-specifically binding, a flow rate window between 70 nl/min to 350 nl/min was required.

FIG. 13 is a graph illustrating the relationship between the flow rate in a micro-channel and the drag force on a 20 μm diameter microsphere estimated using the sphere drag formula of Stokes.

FIG. 14 is a graph illustrating the detection of CEA in human serum using the microfluidic device.

The drawings are described in greater detail in the description and examples below.

The details of some exemplary embodiments of the methods and systems of the present disclosure are set forth in the description below. Other features, objects, and advantages of the disclosure will be apparent to one of skill in the art upon examination of the following description, drawings, examples and claims. It is intended that all such additional systems, methods, features, and advantages be included within this description, be within the scope of the present disclosure, and be protected by the accompanying claims.

### DETAILED DESCRIPTION

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of medicine, organic chemistry, biochemistry, molecular biology, pharmacology, and the like, which are within the skill of the art. Such techniques are explained fully in the literature.

It must be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

As used herein, the following terms have the meanings ascribed to them unless specified otherwise. In this disclosure, “comprises,” “comprising,” “containing” and “having” and the like can have the meaning ascribed to them in U.S. Patent law and can mean “includes,” “including,” and the like; “consisting essentially of” or “consists essentially” or the like, when applied to methods and compositions encompassed by the present disclosure refers to compositions like those disclosed herein, but which may contain additional structural groups, composition components or method steps (or analogs or derivatives thereof as discussed above). Such additional structural groups, composition components or method steps, etc., however, do not materially affect the basic and novel characteristic(s) of the compositions or methods, compared to those of the corresponding compositions or methods disclosed herein. “Consisting essentially of” or “consists essentially” or the like, when applied to methods and compositions encompassed by the present disclosure have the meaning ascribed in U.S. Patent law and the term is open-ended, allowing for the presence of more than that which is recited so long as basic or novel characteristics of that which is recited is not changed by the presence of more than that which is recited, but excludes prior art embodiments.

Prior to describing the various embodiments, the following definitions are provided and should be used unless otherwise indicated.

### DEFINITIONS

The term “antibody” as used herein refers to an immunoglobulin able to specifically recognize and bind to a target moiety such as, but not limited to, a region of another polypeptide, a small molecule or any other molecular entity. The term “antibody” is intended to encompass, but not be limited to, a polyclonal antibody, a monoclonal antibody, a mixture thereof, or a fragment of an antibody such as an Fab, Fv fragment, a recombinant immunoglobulin, a chimeric polypeptide where one region of the polypeptide is a target binding region of an immunoglobulin, a single-chain antibody and the like.

The term “micro-channel” as used herein refers to a space within a block material through which a fluid may pass unidirectionally. It is contemplated that the micro-channels of the present disclosure will be configured to allow the passage of a fluid between the locations of at least two electrodes such that a current may be passed from one electrode to the other through the fluid. It is further contemplated that any micro-channel of the devices of the present disclosure will have at least two ports communicating with the micro-channel to allow for the delivery and removal of the fluid from the micro-channel. While it is not the intention to hereby limited the dimensions of the micro-channels of the disclosure, advantageous micro-channels may have a cross-sectional dimensions in the order of microns, rather than millimeters or larger.

The term “particulate target” as used herein refers to a particle of a size to freely pass through the micro-channels of the devices of the disclosure unless bound to a target binding site on or between the electrodes of the devices. The particles may be cells, including isolated mammalian or plant cells, fungal cells or spores including yeast cells, bacteria and spores thereof such as, but not limited to, Bacillus spp. spores, anthrax spores and the like, and viruses. Particulates that may cause impedance changes detectable by the devices of the disclosure may further include non-vital particles such as dust, atmospheric contamination, or other particles that may be suspended in a fluid suspension medium. Most advantageously, the particles of the disclosure include polymeric micro-spheres to which may be attached a polypeptide or oligonucleotide target of interest, an antibody capable of tethering a target molecule to the micro-sphere, a polysaccharide, organic or inorganic, including metallic ion moieties also able to tether or link a target molecule to the surface of the micro-sphere.

The term “polymeric overlay” as used herein refers to a polymeric form into which a micro-channel may have been molded as an indentation where the indentation is configured as a micro-channel. The polymeric material may be any suitable for forming the molded form and able to be lifted from a template negative form.

The term “target-specific binding agent’ may be any molecule capable of selectively binding to a target of interest such as, but not limited to, a cell, a particulate target, a protein, a polypeptide, an oligonucleotide and the like. The target-specific binding agent may be attached to a polymeric microsphere, or to a region between the electrodes of the devices of the disclosure.

The terms “polypeptide” or “protein” as used herein are intended to encompass a protein, a glycoprotein, a polypeptide, a peptide, and the like, whether isolated from nature, of viral, bacterial, plant, or animal (e.g., mammalian, such as human) origin, or synthetic, and fragments thereof. A preferred protein or fragment thereof includes, but is not limited to, an antigen, an epitope of an antigen, an antibody, or an antigenically reactive fragment of an antibody.

As used herein, the terms “oligonucleotide” and “polynucleotide” generally refer to any polyribonucleotide or polydeoxyribonucleotide that may be unmodified RNA or DNA or modified RNA or DNA. Thus, for instance, polynucleotides as used herein refers to, among others, single- and double-stranded DNA, DNA that is a mixture of single- and double-stranded regions, single- and double-stranded RNA, and RNA that is mixture of single- and double-stranded regions, hybrid molecules comprising DNA and RNA that may be single-stranded or, more typically, double-stranded or a mixture of single- and double-stranded regions. The terms “nucleic acid,” “nucleic acid sequence,” or “oligonucleotide” also encompass a polynucleotide as defined above. Typically, aptamers are single-stranded.

As used herein, the term “polynucleotide” includes DNAs or RNAs as described above that may contain one or more modified bases. Thus, DNAs or RNAs with backbones modified for stability or for other reasons are “polynucleotides” as that term is intended herein. Moreover, DNAs or RNAs comprising unusual bases, such as inosine, or modified bases, such as tritylated bases, to name just two examples, are polynucleotides as the term is used herein.

### Description

### Bioactivated Microfluidic Channels

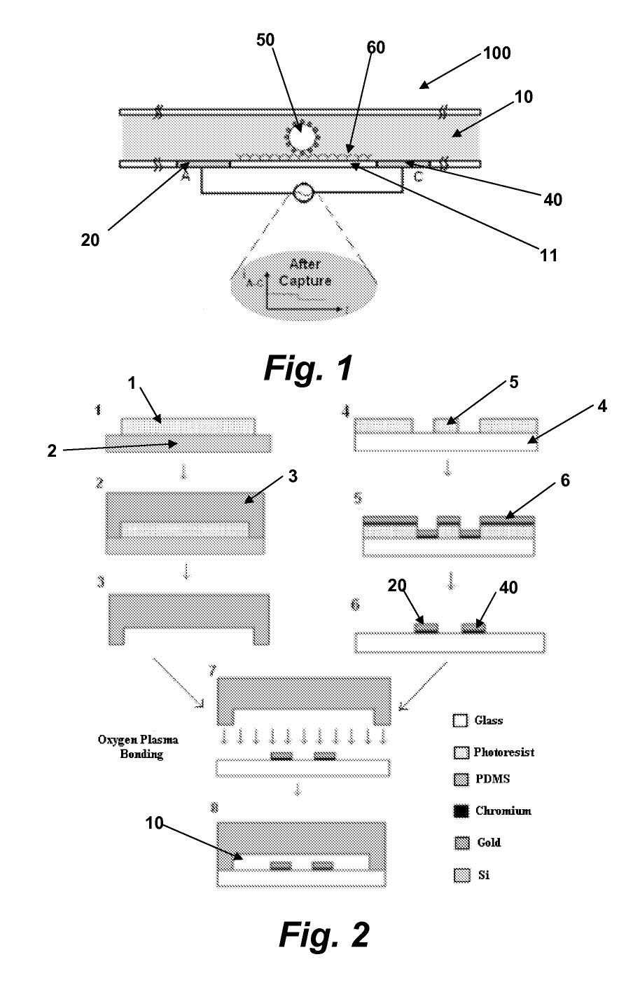

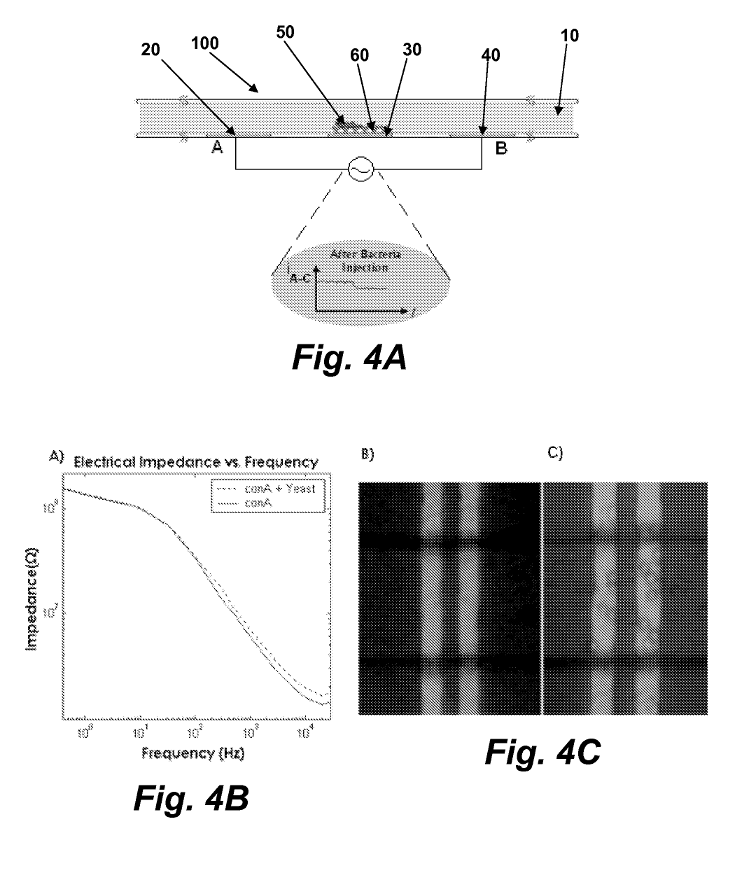

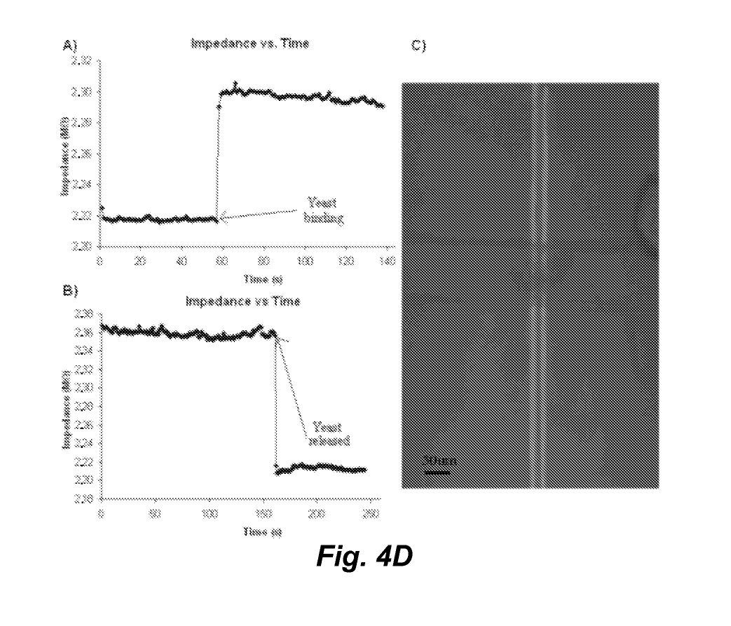

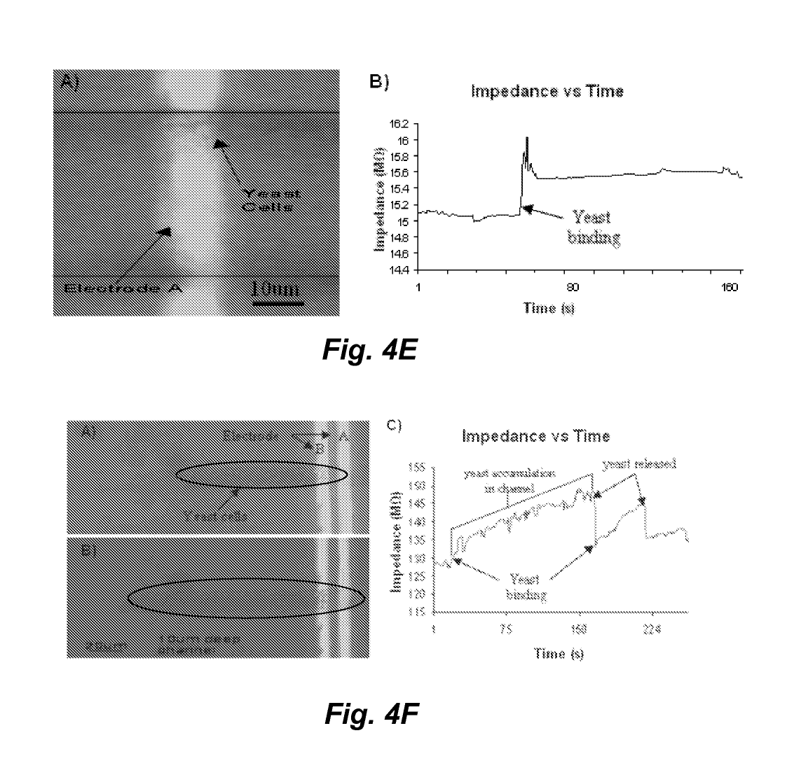

Referring now to FIGS. 1, 2, and 3E, one embodiment of the disclosure is a basic gated micro-channel device 100 having a micro-channel 10 and two electrodes 20, 40 disposed within the micro-channel 10. The two electrodes 20, 40 are positioned within the micro-channel 10 whereby, when the electrodes 20, 40 are electrically connected to a power source 70, a current passes from one electrode to the other and through the micro-channel 10. The electrodes 20, 40 may also be connected to a signal amplification device 80 and a data acquisition device 90 that may be used for measuring and/or recording a current across the channel 10. The region in between the electrodes 20, 40 is the active area of the sensor. Probe molecules 60 specific and complementary to a target under study may be immobilized on the base 11 of the channel 10, and between the electrodes 20, 40. In some embodiments of the micro-channel device 100 of the disclosure, a third metallic electrode 30 may be disposed between electrodes 20, 40 to receive the probe molecules 60, as shown for example, in FIG. 4A. Suspensions of particles or beads 50, which can be, but are not limited to, functionalized beads, target cells, or any other type of biomarkers under study may be delivered into the micro-channel 10 via an entry port 12 and may exit the micro-channel 10 via an egress port 13, both ports 12, 13 communicating with the channel 10.

If the desired specific interactions occur between the target biomarker and the probe molecule 60, the target particle 50 will be captured in the active area of the sensor. This results in partial occlusion of the channel 10 and causing a decrease in the current across the electrodes 20, 40 that can be detected and measured as an increase in impedance.

By tailoring the geometry of the micro-channel 10 to the bead 50 size, the electrical detection limit can be adjusted to single-microsphere detection. The resistance change resulting from a particle 50 passing through a micro-channel 10 is given by the equation [1]:

$$Δ R = 2 {ρ}_{sol} [ \frac{a tan ( \frac{h}{2 \sqrt{\frac{{A}_{c}}{π} - \frac{{h}^{2}}{4}}} )}{π \sqrt{\frac{{A}_{c}}{π} - \frac{{h}^{2}}{4}}} - \frac{{h}^{2}}{4 {A}_{c}} ] \qquad ( 1 )$$

where h is the diameter of the bead or microsphere 50, ρₛₒₗ is the resistivity of the solution, and A_{c} is the product of the height and the length of the channel 10.

This equation applies to a bead 50 positioned in the center of the active area of the sensor. The current change will be larger, however, for a bead 50 which may be positioned nearer to the electrodes 20, 40. As the bead or microsphere 50 moves closer to the electrodes 20, 40, and farther away from the center, the current change resulting from the presence of the bead 50 in the active region increases. Smaller micro-channel 10 cross sections also result in larger current changes, as do smaller distances between electrodes results in larger current change.

There are three primary sources of noise in this system. They are the thermal noise resulting from the solution resistance of the electrolyte, the amplifier noise from the amplifying and read out circuitry, and the noise from the analog-to-digital converter. For a 50 μm×50 μm sized channel 10 and electrodes 20, 40 spaced 250 μm apart, the noise in the system was about 1% of the baseline signal, meaning that beads 50 captured in the active region of the channel 10 preferably produce a resistance change of at least 1% to be detected.

The rate at which particles 50 are captured in the active area of the micro-channel device 100 can be limited by the hit rate of the beads 50 passing through the micro-channel 10 in the active area, and the rate at which functionalized beads 50 making contact with the active area surface successfully bind to the immobilized receptor proteins. This is limited by the binding kinetics of the two interacting molecules.

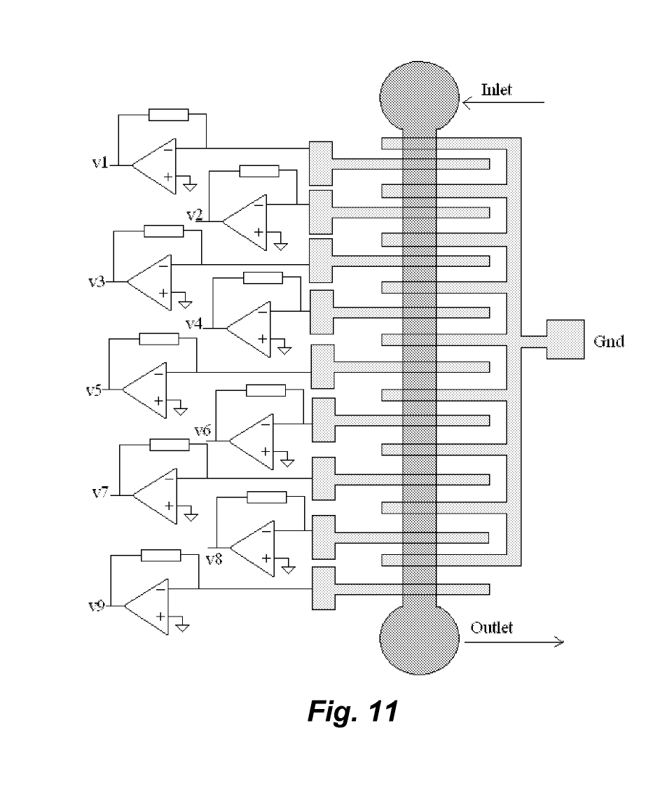

At smaller channel geometries, non-specific binding of beads and channel clogging may become significant. However, the hit rate of particles is significantly increased with an increasing active area. The active area of the sensor can be increased by increasing the spacing between the electrodes. However this decrease is offset by an increase in the electrical sensitivity. Another method for increasing the active area size without compromising the electrical sensitivity involves integrating multiple sets of electrodes across the channel 10. An embodiment of such a multi-channel device is shown in FIG. 11. A large active area length (>5 mm) allows for the contact of more than 50% of the beads passing through the channel. The detection limit of the biosensor device of the disclosure is determined by the number of beads required to pass through the channel before the minimum number of beads are captured in the active area of the sensor, thereby causing a change in impedance greater than the detection threshold of the sensor.

### Cell Detection

The impedance-based sensor devices of the present disclosure are advantageous since they eliminate the need for fluorescence labeling. Current electrical impedance sensors require numerous washing steps and lack the ability for real time detection. Flow-cytometry based methods such as the use of coulter counters have provided the ability to analyze the dielectric properties of a cell in real time. These devices operate, however, on the principle of measuring a current change caused by the displacement in the fluid as the particle passes by two measuring electrodes. A device relying solely on this principle cannot readily distinguish two different types of cells that may have similar dielectric properties and would have difficulty in detecting a target cell in a complex mixture.

The embodiments of the disclosure provide an apparatus suitable for real time detection of target cells. This method utilizes impedance measurements at about 29.8 kHz to probe solution resistance changes associated with the blockage of ionic current due to cell binding on the channel walls in the active area of the sensor. The method can be used for detection of any suitable particulate target including, but not limited to, inorganic particles, non-cellular organic particles, yeast cells, bacteria, bacterial spore, mammalian cells, and the like, and for such uses as testing water quality for possible contaminants. It is contemplated that the geometry of the micro-channel, and the deposition of the electrodes within the micro-channel may be configured to optimize the device for detecting a particular particulate target. To extend this method to applications like the detection of bacterial cells, and maintain the high electrical sensitivity of the device, it is necessary, therefore, to reduce the size of the channel geometries, making it the micro-channel more compatible to the smaller dimensions of bacterial cells, in comparison to yeast cells. An advantage of the devices of the disclosure are their selectivity in cell capture, which makes it possible to multiplex an array of these sensors onto a single chip and probe a solution to determine which types of cells it contains.

The detection limit can be enhanced by effectively increasing the active area of the device by integrating multiple sets of electrodes across the channel, as illustrated in FIG. 11 for example. Further enhancements of sensitivity may be achieved by adopting an immobilization procedure which results in antibodies being immobilized predominantly on the gold electrodes, as opposed to the entire channel length. Multiple recycling of the solution in the channel may also help with capturing cells which may have already passed through the channel without attaching to the electrodes.

The real-time detection selectivity of the devices and methods of the present disclosure was first demonstrated using yeast cells as target cells and Concanavalin A (Con A), a glycoprotein with affinity for the sugar molecules on yeast surface.

The basic device (as shown in FIG. 4A for example) used in these experiments included three electrodes 20, 30, 40 disposed across the micro-channel 10 of the device 100. The channel current is monitored between electrodes 20, 40. The volume between electrodes 20, 40 comprises the active area of the sensor. A third gold electrode, 30, may be disposed within the active area of the channel, allowing for immobilization of antibodies or other protein probe molecules 60 with an affinity to bind to target cells 50 or other particulate targets in the active area of the sensor.

Gold electrodes are suitable for surface chemistry modifications, such as deposition of surface assembled monolayers that will optimize the immobilization of proteins such as, but not limited to, antibodies. It is contemplated that the sensor area between the electrodes 20, 40 may have disposed therein any metal that may allow the attachment and immobilization thereto, including, but not limited to, gold, silver, copper, iron and the like. It is further contemplated that the area between the two electrodes 20, 40 may be any non-metallic material able to allow attachment and immobilization of a protein or other ligand, such as, but not limited to, glass, plastic, a polymer, and the like. The surface may also comprise tethers or linkers to attach the protein to the surface. Preferably, however, a metal insert is inert and resistant to degradation or erosion during passage of a fluid through the micro-channel, or from electrolytic effects. Most desirable, therefore, is gold due to its durability, resistance to erosion or corrosion, and the ability to accept and retain polypeptides on the surface thereof.

A sample fluid suspected of containing the target cells may be delivered via an entry port 11 into the micro-channel 10. If the sample contains the targeted particulate matter, the particles 50 will attach to the electrodes, partially clogging the channel thus resulting in a solution resistance increase. By monitoring the impedance across micro-electrodes 20 and 40, it was possible to detect the channel gating caused by particles attached inside the channel. By choosing channel and electrode geometries close to the bacteria size, the probability of bacterial cells being captured by the electrodes and thereby generating impedance changes are maximized.

For selective detection to be achieved, this technique uses a channel geometry that closely correspond to that of the target cell and that the target cell contain surface markers specific for the probe molecules, such as, but not limited to, polyclonal or monoclonal antibodies immobilized in the active area of the sensor. It is anticipated that the detection of target yeast cells can be extended for detection of all types of cells including bacteria or cancer cells in blood. However, it is contemplated that the channel 10 geometry must be tailored to the type of cell which is being targeted.

### Characterization of Protein-Protein Interactions

The main challenge for rapid characterizations of protein interactions rests in establishing an inexpensive and simple procedure requiring small reagent volumes capable of detecting real time protein binding. Also of necessity is a technique that can be easily multiplexed allowing the simultaneous study of different proteins. Protein microarrays are advantageous since they open the possibility for multiplexed analysis of different proteins simultaneously. The disadvantage of using protein microarrays, however, as with all other fluorescence based detection techniques, lies in the high reagent costs involved and the long incubation times. Such sensors lower the reagent costs and preparation time since they eliminate the need for fluorescence labeling. Protein detection has been described using nanogap sensors. However, impedance sensors still require numerous washing steps and lack the ability for real time detection.

The chip-based microfluidic devices of the disclosure are useful, therefore, for real time detection of protein-protein interactions, such as, but not limited to, glycoprotein-glycoprotein interactions, antibody-antigen interactions, antigen-glycoprotein interactions, and the like. For example, for studying antigen-antibody interactions, human chorionic gonadotropin (hCG) and anti-hCG antibody were used. For glycoprotein-glycoprotein interactions, the binding between Con A and lactoperoxidase was used. The affinity between hCG and Con A was used as an example of antigen-glycoprotein interactions.

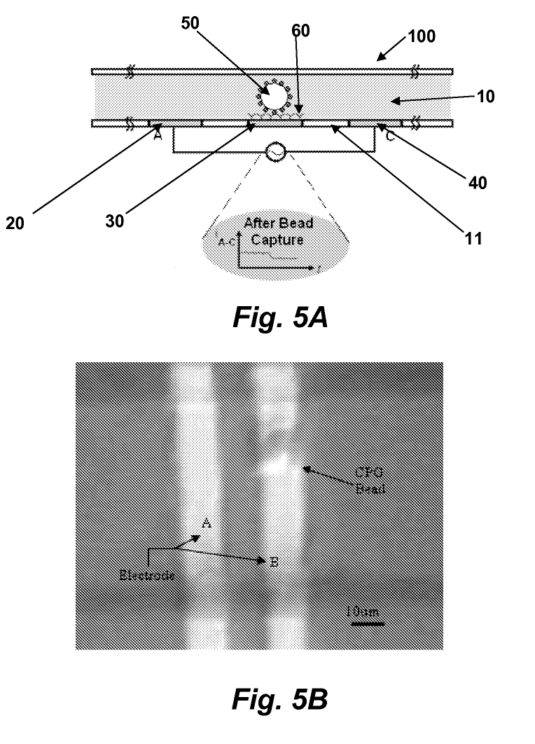

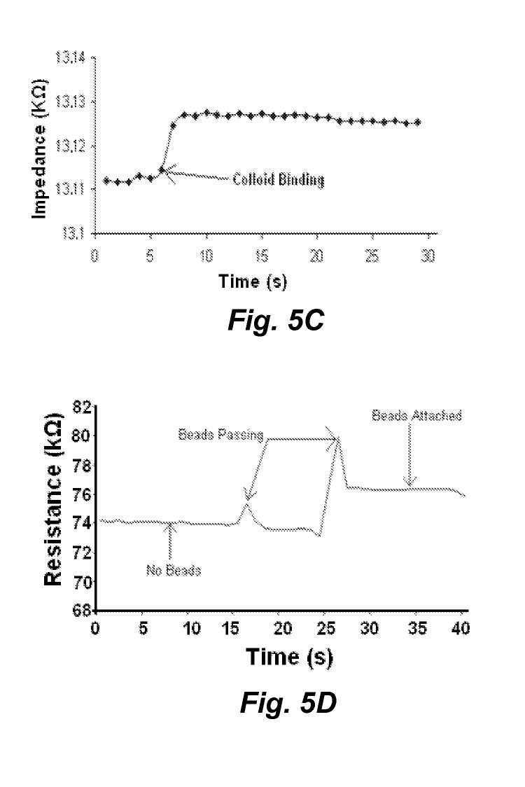

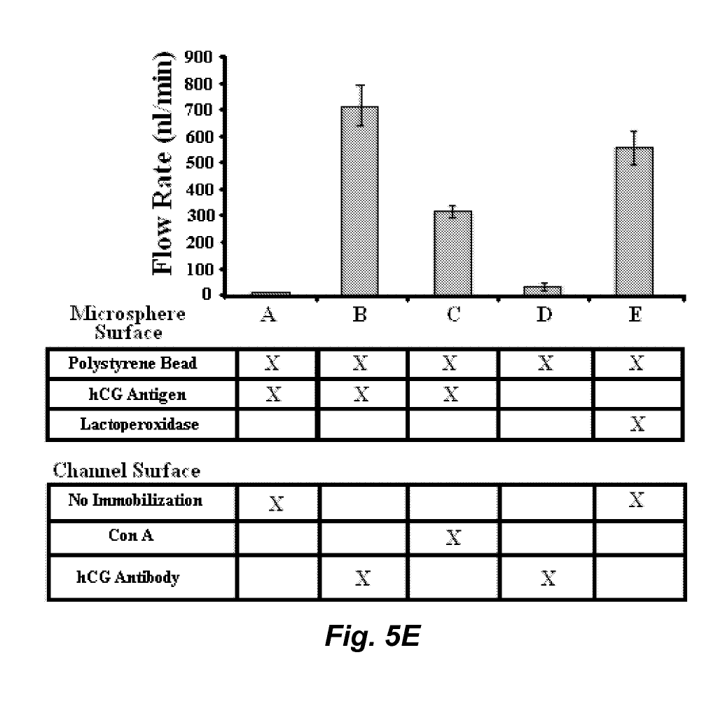

Referring now to FIG. 5A and Examples 10-15 below, embodiments of the basic micro-channel device 100 for detection of biomolecular interactions may comprise at least two electrodes 20, 40 that are used for measuring the impedance across the channel 10. The region in between electrodes 20, 40 is the active area of the sensor. Protein receptors specific and complementary to the protein under study, are immobilized on the base of the channel between electrodes 20, 40. As mentioned above, by patterning a gold region in between electrodes 20, 40, or by providing an alternative surface that may bind polypeptides thereto, the surface becomes optimal for immobilization of protein receptors to a desired orientation. This is because gold is suitable for surface chemistry modifications, such as deposition of self assembled monolayers. Beads 50, functionalized with the target protein may be delivered into the micro-channel 10. If the desired interactions occur between the proteins, the beads will be captured in the active area of the sensor. This results in a partial occlusion of the channel 10, causing a decrease in the current across electrodes 20, 40.

The methods of the disclosure provide an electrical method for real time analysis of protein-protein interactions. This method is based on resistance changes in the probing solution caused by blockage of ionic current due to functionalized beads binding on the surface of a bioactivated micro-channel. It is contemplated that antigen-antibody interactions, glycoprotein-glycoprotein interactions, antigen-glycoprotein interactions, and the like may be monitored using the devices and methods disclosed. An advantage of this technique is its selectivity in bead capture, allowing for the possibility of multiplexing an array of sensors onto a single chip and detecting a wide panel of protein-protein interactions.

The selectivity of the methods of the disclosure can be enhanced by immobilizing a primary antibody onto the microsphere and the secondary antibodies on the channel surface. This allows an extra level of specificity given that the bead is functionalized only with the protein of interest, making it suitable for analyzing a complex mixture of proteins.

Protein Biomarker Detection with Bioactivated Micro-Channel

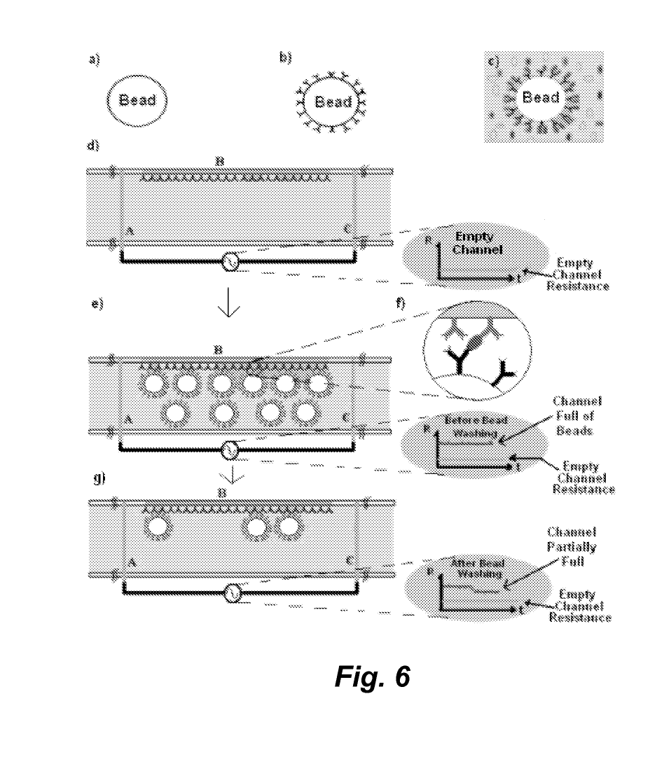

Referring now to FIG. 6, in the micro-channel gating methods for protein biomarker detection of the present disclosure, micron sized beads 50 (FIG. 6A) may be coated with primary receptors (FIG. 6B) and then the targeted protein biomarker is captured as the functionalized beads are immersed in a multi-analyte solution (FIG. 6C). FIG. 6D shows an embodiment of the disclosure of a protein-functionalized micro-channel biosensor, with gold electrodes 20, 30, 40. Protein receptors 61 with affinities to target biomarkers are immobilized on the surface of electrode 30. The beads 50 may then be injected into the micro-channel 10 (FIG. 6E), partially occluding the channel 10 resulting in a resistance higher than the baseline value. If any of the bead surfaces are labeled with the targeted biomarkers, the beads 50 will attach to the receptors on the channel wall. After the beads 50 have come to rest, a flow is applied across the channel 10 causing the unbound beads 50 to be washed out of the channel, resulting in a drop in the ionic solution resistance depending on the number of beads 50 remaining (FIG. 6F). The number of beads remaining attached is proportional to the targeted protein biomarker concentration. A high concentration of target biomarkers will result in a smaller drop in resistance compared to a low concentration of biomarkers. Thus, in addition to being able to detect the presence of protein biomarkers at low concentration, the sensor device of the disclosure also provides the ability to measure the concentration of the target biomarker.

The requirement for successful detection of the target biomarker is that the surfaces of the microspheres contain primary receptors and that the active area of the sensor contains secondary receptors, both of which should be able to specifically bind to the targeted biomarker. It is also necessary that the microspheres used be comparable in size to that of the channel geometry.

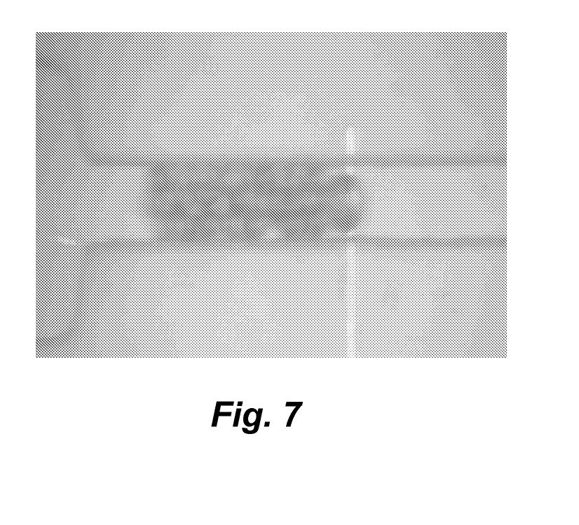

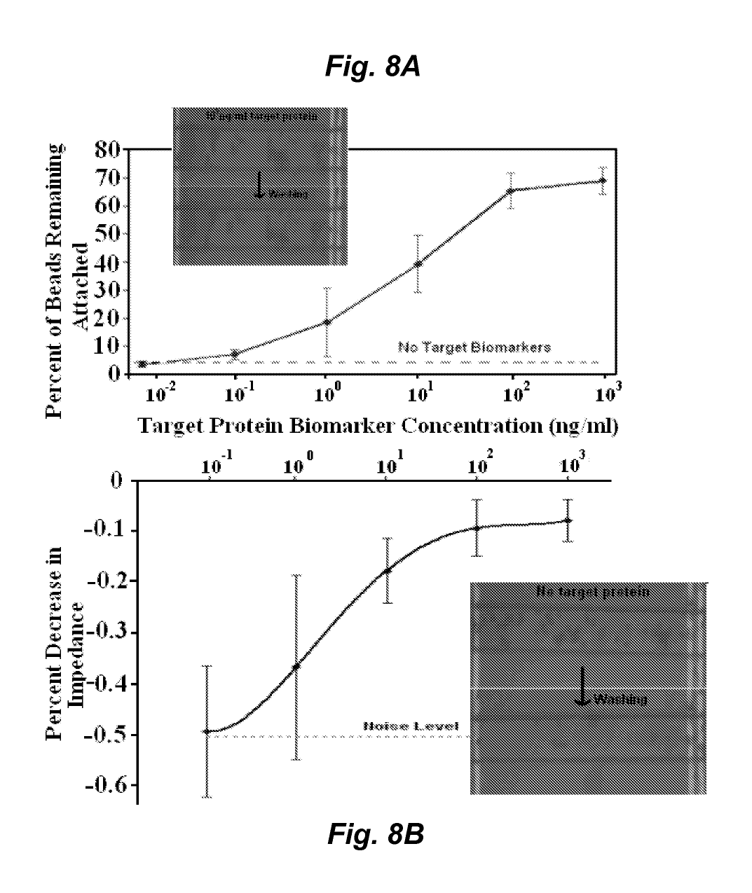

To demonstrate the ability of the methods of the disclosure to detect a target biomarker, real time electrical measurements were performed, where we looked at the percentage drop in resistance across the channel was examined. The percent change actually provides information as to how many beads are removed from the channel as compared to how many were present before the washing step. The electrical measurements are shown in real time (FIG. 7) as the channel was washed. As the flow was applied to the channel, the unbound beads are flushed out of the channel. As the concentration of the target protein biomarker decreased, the drop in the electrical impedance increases. The decrease in the target biomarker concentration results in more beads being removed from the sensing area of the channel (FIG. 7), thus resulting in a larger drop in impedance across the electrodes. When the target concentration is 1 μg/ml, almost all of the beads remain attached (FIG. 8A) corresponding to no change in the impedance, as opposed to the scenario where no target protein was present in the test sample resulting in almost all of the beads being removed from the base of the channel, with the exception of a few which remain attached due to nonspecific binding. This corresponds to the largest drop in impedance (FIG. 8B).

The ability of this technique to quantify target protein biomarkers in detail by performing this assay was analyzed over a wide range of target protein concentrations. The assay was confirmed optically (inset, FIG. 8A), where the beads in the channel were counted before and after washing. The standard error bars for over five different experiments for each data point is included. A dynamic range of three orders of magnitude and a repeatable lower detection limit of approximately 1 ng/ml (7 pM) was demonstrated. The percentage decrease in electrical resistance measured as a function of target biomarker concentration is shown in (inset, FIG. 8B) confirming the optical results. Decrease in target biomarker concentration results in more beads being removed from the sensing area of the channel, thus resulting in a larger drop in resistance across the electrodes.

The standard error bars for the electrical measurements are greater than the standard error bars for the optical measurements. The impedance sensitivity to the location of the beads between the electrodes is the main cause for this inconsistency. There are several methods possible for reducing the standard error bar for the electrical quantification measurements, which we are currently exploring. One possibility is to integrate interdigitated electrodes at the base of the channel across the whole channel, effectively increasing the active area of the sensor without any compromise in the electrical sensitivity of the sensor. Another possibility is to integrate multiple sets of electrodes across the whole channel, which will not only effectively increase the active area of the sensor, it will also have a higher electrical sensitivity than a channel with interdigitated electrodes.

### Detection of DNA Hybridization

A rapid and inexpensive methodology for detecting the hybridization of two DNA strands can be useful in detecting the presence of certain genes in a patients DNA. By detecting such gene sequences it is possible to determine whether a patient has predisposition to a certain type of disease allowing him to get treatment to prevent the disease. Currently DNA hybridization is detected using techniques such the use of DNA microarrays and also real-time PCR. Such techniques are expensive given that they require the use of fluorescent labels which results in high reagent costs. The other major cost comes from the use of expensive and bulky optical scanners required for reading the fluorescent signals. DNA hybridization also requires overnight incubation given that thousands of molecules must hybridize to produce enough optical signal to be readable by the fluorescent scanner.

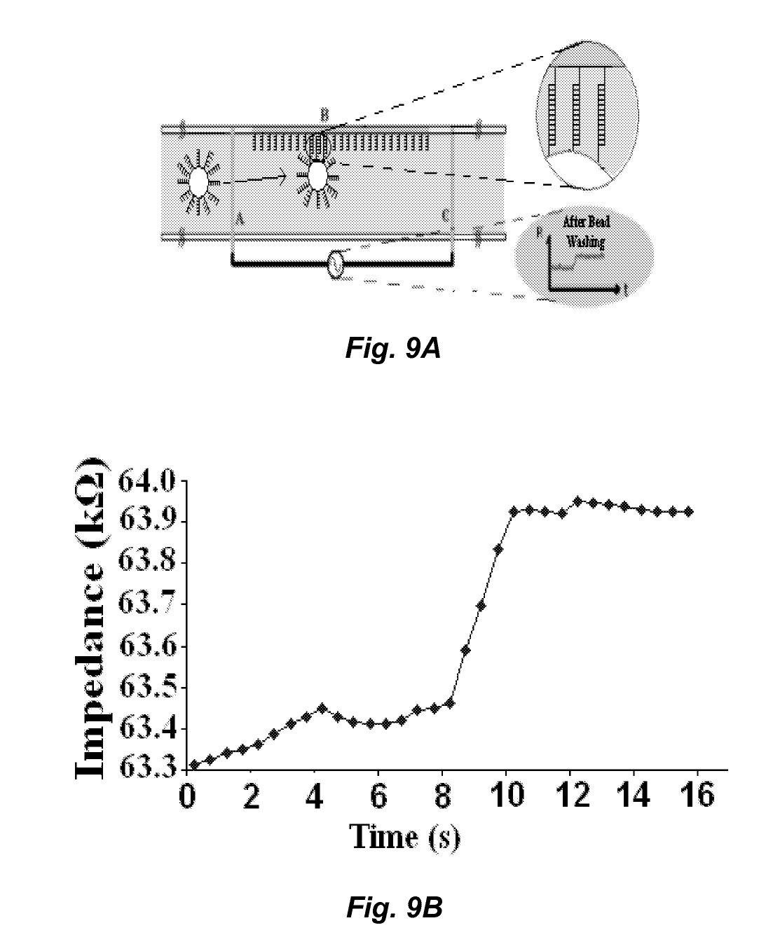

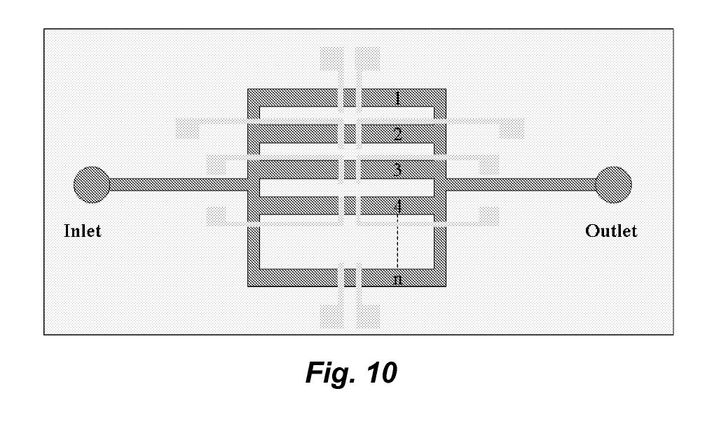

The microfluidic biochip devices of the disclosure electrically detect the hybridization of two complementary DNA strands within seconds, without the need of any fluorescent labels. In the micro-channel gating methods for DNA biomarker detection of the disclosure, DNA probe molecules are immobilized on the surface of the micro-channel. Target DNA molecules are immobilized on the surface of micron sized beads. The beads are then injected into the micro-channel (FIG. 9A) partially clogging the channel resulting in an instantaneous increase in the baseline resistance (bottom inset, FIG. 9A). The requirement for successful detection of the DNA hybridization (bottom inset, FIG. 9A) is that the surfaces of the microspheres contain target DNAs which are specific and complementary to the probe DNAs immobilized on the active area of the sensor. To be able to detect the hybridization resulting in the capture of a single bead, it is also necessary that the microspheres used be comparable in size to that of the channel geometry.

One aspect of the disclosure, therefore, provides methods for selectively detecting a particulate target comprising: (a) determining a first electrical impedance of a first fluid disposed in a micro-channel, wherein the micro-channel comprises a surface having a first target-specific binding agent bound thereto, a first electrode and a second electrode, wherein the first and second electrodes are configured to deliver an electrical current through a fluid disposed in the micro-channel; (b) delivering to the micro-channel a test fluid suspected of comprising a target to be detected, wherein the target is a particulate target or a non-particulate target bound to a particle; (c) washing the micro channel with a second fluid, wherein the first and the second fluids have the same composition; and (d) determining a second electrical impedance of the second fluid disposed in the micro-channel, whereby a difference between the first impedance and the second impedance indicates that a particulate target or a non-particulate target bound to a particle is present in the test fluid.

In embodiments of this aspect of the disclosure, the first target-specific binding agent may be selected from the group consisting of: a protein, a polypeptide, an oligonucleotide, a saccharide, a polysaccharide, and an antibody.

In the embodiments of this aspect of the disclosure, the first target-specific binding agent may be bound to a glass surface of the micro-channel.

In embodiments of this aspect of the disclosure, the micro-channel may further comprise a third electrode disposed between the first electrode and the second electrode.

In the embodiments of this aspect of the disclosure, first target-specific binding agent may be bound to a surface of the third electrode, disposed in the micro-channel.

In the embodiments of the methods of this aspect of the disclosure, the particulate target is a cell selected from the group consisting of: an animal cell, a plant cell, a fungal cell, a protozoal cell, and a bacterial cell, and wherein the particulate target has a size sufficient to modify the impedance of the micro-channel when the target is bound thereto.

In the embodiments of this aspect of the disclosure, the non-particulate target bound to a particle can comprise a polymeric bead and a target ligand bound thereto, and the target ligand can be, but is not limited to, a ligand selected from the group consisting of a protein, a polypeptide, an oligonucleotide, a saccharide, a polysaccharide, and an antibody.

In yet other embodiments of this aspect of the disclosure, the particulate target may further comprise a target molecule selectively bound to the ligand, and wherein the target molecule is capable of being selectively bound to the first target-specific binding agent in to the micro-channel.

Another aspect of the disclosure provides microfluidic devices for detecting a target, comprising: a micro-channel defined by a channel in an polymeric overlay, wherein the polymeric overlay is bonded to a substrate, and wherein the micro-channel is further defined by a surface of the substrate; a first electrode and a second electrode, wherein each of the first and the second electrodes extends into the micro-channel and are configured for passing of an electrical current through the micro-channel; a fluid entry port and a fluid exit port, the entry and exit ports each communicating with the micro-channel.

In this aspect of the disclosure, embodiments of the microfluidic device may further comprise a target-specific binding agent bound to the interior of the micro-channel.

In other embodiments of the microfluidic device, the device may further comprise a third electrode disposed in the micro-channel and between the first electrode and the second electrode, wherein the target-specific binding agent is bound to the third electrode.

In still other embodiments of the disclosure, the first target-specific binding agent may be selected from the group consisting of: a protein, a polypeptide, an oligonucleotide, a saccharide, a polysaccharide, and an antibody.

In yet other embodiments, the first target-specific binding agent may directly bonded to a surface of the micro-channel.

In still other embodiment of the microfluidic device of the disclosure, the device may further comprise a plurality of micro-channels, wherein each micro-channel is defined by a channel in an overlay bonded to a substrate, and further defined by a surface of the substrate, and each micro-channel further comprises a first electrode and a second electrode, wherein each of the first and the second electrodes extends into the micro-channel, and a the device further a fluid entry port and a fluid exit port, the entry and exit ports each communicating with the plurality of micro-channels, and each the micro-channel.

In other embodiments of the microfluidic device of the disclosure, the device may further comprise an adjustable electrical power source, a signal amplifier, a computation system and a display wherein the microfluidic device, the adjustable electrical power source, the signal amplifier, the computation system and the display means are cooperatively linked to provide a measurement of the impedance through the micro-channel of the device.

The specific examples below are to be construed as merely illustrative, and not limitative of the remainder of the disclosure in any way whatsoever. Without further elaboration, it is believed that one skilled in the art can, based on the description herein, utilize the present disclosure to its fullest extent. All publications recited herein are hereby incorporated by reference in their entirety.

It should be emphasized that the embodiments of the present disclosure, particularly, any “preferred” embodiments, are merely possible examples of the implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure, and the present disclosure and protected by the following claims.

The following examples are put forth so as to provide those of ordinary skill in the art with a complete disclosure and description of how to perform the methods and use the compositions and compounds disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is at or near atmospheric. Standard temperature and pressure are defined as 20° C. and 1 atmosphere.

### EXAMPLES

### Example 1

### Micro Fabrication and Experimental Protocols

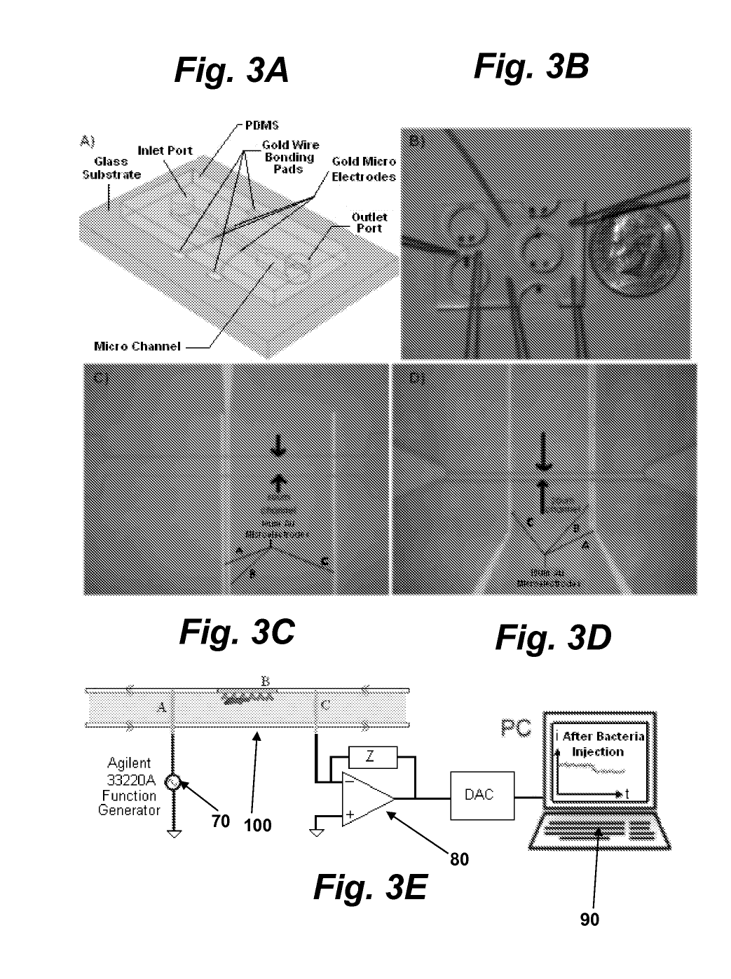

(i) Device design: One embodiment of the micro-channel device of the disclosure is illustrated in FIG. 3A. Multiple channels were fabricated onto a single chip as shown in FIG. 3B. Experiments were conducted on two sets of channel sizes, one 50 μm deep and 50 μm wide (FIG. 3C), and the other 20 μm wide and 10 μm deep (FIG. 3D). The electrodes (10 μm in width) were separated from each other by 270 μm.
(ii) Electrode and Micro-channel Fabrication: The fabrication steps for the manufacture of a microfluidic device are illustrated in FIG. 2, and are as follows: (1) a master mold 1 of a channel micro is patterned onto a silicon wafer 2 using SU-8 photoresist epoxy resin; (2) PDMS 3 is poured onto the master mold 1 in gel form and then cured; (3) the PDMS layer 3 is then peeled off. Gold/Chromium electrodes 20 and 40 (2000 Å and 150 Å thick respectively) were fabricated on a glass wafer using photolithography, sputtering, and then lift-off processing, methods well known to those of skill in the art; (4) The electrodes are micro patterned onto the glass wafer 4 using SU-8 photoresist epoxy resin 5; (5) The wafer 4 is then sputtered with a layer of chromium and then gold 6; (6) Lift off processing is used to removed the unwanted gold 6 and photoresist 5; (7) The glass wafer was then diced into individual chips to prepare them for bonding to a PDMS cover. The glass wafer 4 with electrodes 20 and 40, and the PDMS layer 3, are then cleaned in an oxygen plasma oven and aligned together; and (8) then bonded with each other.

### Example 2

### Device Measurement and Characterization

Electrical impedance measurements were collected across the channel in the region between electrodes A and C. A voltage signal was applied to electrode A and the current measured at electrode C using a current pre-amplifier (E1-400 Potentiostat Ensman Instruments, Bloomington, Ind.) and then the data was collected with a National Instruments data acquisition card and read by a Labview program. The channels were also monitored using optical microscopy to confirm that the signal changes were due to beads binding in between the electrodes. The physical processes occurring at the interface between the electrode and the electrolyte and also the bulk solution directly dictate the impedance behavior. The small separation of the layer of accumulated ions results in the double layer capacitance dominating the impedance at low frequencies. Effects such as the Warburg impedance and the electron transfer resistance also significantly affect the impedance at low frequencies.

It is desirable to minimize the effect on the impedance resulting from all impedances except for the bulk solution resistance. This can be achieved by working at sufficiently high frequencies. Approximately 30 KHz has been found to be an optimum frequency to operate the device according to the disclosure.

### Example 3

### Latex Bead Preparation

For studying antigen-antibody interactions, hCG was attached to the microspheres, and its interactions with polyclonal anti-hCG antibodies physically adsorbed onto the glass base of the channel were measured. Glycoprotein-glycoprotein interactions were tested by examining the interactions of the glycoprotein lactoperoxidase that were immobilized onto the microspheres, and Con A, a glycoprotein with specific affinity to sugar molecules, which was immobilized on the surface of the micro-channel.

A volume of 1.5 ml of latex particles (COOH-functionalized, 10.36 μm, 10% solid, Bangs Laboratories) were added to 5 ml of 30 mM MES buffer, pH 5.5 and the suspension was washed several times by centrifugation and resuspension in this buffer. The washed particles were suspended in a final volume of 18 ml of the MES buffer in a 50 ml BD plastic tube, containing 108 mg of EDC and 55 mg of sulfo-NHS, and shaken on a horizontal shaker at room temperature, fixed at a medium speed, for 55 minutes, while making sure that the particles remained suspended without any precipitation throughout this activation step. The NHS-activated latex particles were then precipitated by centrifugation and washed twice with 80 mM MOPS, pH 8.6, and finally suspended in 9 ml of this buffer. To 3 ml of this suspension, 0.5 ml of a 1 mg/ml hCG or lactoperoxidase, separately made in the MOPS buffer, were added and the suspensions were left on the horizontal shaker at room temperature, fixed at a medium speed, for 5.5 hours, again making sure that no precipitation of the particles took place during this period. Finally, the bead suspensions including latex particles (now with the proteins covalently attached to them) were washed several times with PBS and each finally suspended in 0.5 ml of the buffer and stored in the refrigerator for future use.

### Example 4

### CPG Bead Preparation

Covalent coupling of the proteins to NH₂-activated controlled pore glass (CPG) beads was carried out in a one-step reaction in PBS buffer. For lactoperoxidase, the reaction mixture contained 1 mg of the beads, 2.5 mg of the protein, 7 mg of EDC and 7 mg of sulpho-NHS, in a final volume of 1.5 ml PBS. The suspensions were left on a horizontal shaker for 6 hours at room temperature, making sure that no precipitation took place during this period. The beads were then washed extensively with PBS by centrifugation followed by resuspension. They were finally suspended in 1 ml of PBS and stored in the refrigerator for future use.

### Example 5

### Preparation of Yeast and Con A

Yeast (S. cervisiae) cells were grown and maintained on YPD (Yeast Extract/Peptone/Dextrose) agar plates at 4° C. An isolated colony was used to inoculate 5 ml of YPD broth, and the culture was grown to saturation for 16 hours at 30° C. Cells were then collected by centrifugation and resuspended in a solution containing 200 mM KCl and 10 mM HEPES in addition to 1 mM MgCl₂, 1 mM MnCl₂, and 1 mM CaCl₂ which are necessary for Con A activity. The cell concentration in the final solution was diluted to 10⁷ cells/ml.

The Con A was diluted to 10 mg/ml. Immobilization of Con A on the electrodes was carried out by physical adsorption. Con A solution was injected and incubated in the channel for 15 minutes, then activated by the injection of Mn²⁺, Mg²⁺, and Ca²⁺ ions. A 200 mM KCl solution in 10 mM Hepes buffer with a pH of 6.8 containing yeast was injected into the channel at a flow rate of 100 nl/min.

### Example 6

### Impedance Spectrum

It was necessary to measure the impedance spectrum across the channel to gain a proper understanding of the impedance behavior as a function of frequency as shown in FIG. 4B. FIG. 4C (left) shows the channels before the binding of yeast, and FIG. 4C (right) shows the channel after the yeast cells have been attached inside the channel.

As shown in FIG. 4C (right), yeast cells bind on both the gold electrodes and the glass base of the channel. However, no yeast cells were observed to bind to the PDMS top layer. Therefore, the method of Con A immobilization results in the Con A adsorbing onto both the gold electrodes and on the glass base of the channel. This has the potential to limit the sensitivity of the device since some targeted cells may bind to the channel wall outside the active area of the sensor.

Of particular interest was to find the frequency at which the ionic resistance in the channel begins to dominate the impedance. As seen in the impedance spectrum, the binding of yeast cells on the channel walls in the region between electrodes A and C results in an increase in impedance at frequencies above 100 Hz. Based on the impedance curve, it can be seen that the solution resistance begins to dominate the impedance at frequencies above 10 kHz. The binding of yeast to Con A on the electrode results in an increase in ionic impedance at frequencies above 10 kHz indicating that impedance changes can be achieved resulting from ionic solution resistance increase

### Example 7

### Binding Specificity

To achieve real time detection, the electrical impedance was measured over time between electrodes 20, 40 at a frequency of 29.8 kHz in the 50 μm deep channel. This frequency was optimum for the system under test, since the ionic impedance is dominated by solution resistance.

FIG. 4D (right) shows a clump of approximately 30 yeast cells binding onto electrode 20 resulting in an instantaneous increase in impedance at time t=59 secs, as shown in FIG. 4D (top left).

In a separate experiment (FIG. 4D (bottom left), impedance measurements were taken as a clump of yeast was already bound onto the electrodes. At time t=155 secs, the yeast cells were removed by increasing the pressure slightly, which resulted in an instantaneous decrease in impedance. As seen in FIG. 4D (bottom left), the noise level is 0.02 MΩ, which is 1% of the base value of 2.22 MΩ. A change of 0.8 MΩ resulted from the binding of a clump of approximately 30 cells. This meant that at least eight cells need to bind to the electrodes to cause a change greater than the noise level. To increase the electrical sensitivity to the single cell level, optimization will consist of decreasing the cross sectional area of the micro-channel by a factor of eight.

### Example 8

### Large Channel Experiments

FIG. 4E (left) shows yeast cells being captured by the receptors on the electrode surface in the 50 μm deep channel. Results in FIG. 4E (right) show an instantaneous increase in electrical impedance as a small number of cells bind to the surface of the electrodes, demonstrating real time detection of cell capture. A current change of 2.6% resulted from several cells binding onto the electrode.

To verify that binding of the cells to the channel walls was as a result of specific antigen-antibody interactions, two different control experiments for the 50 μm deep channels were conducted. A 200 mM KCl solution in 10 mM Hepes buffer with a pH of 6.8 containing yeast cells was injected at a flow rate of 100 nl/min into a channel in which Con A had not been immobilized on the surface. To further confirm the specificity, the surface of yeast was treated with α-mannosidase and α-glucosidase for removing the sugars, mannose and glucose which have an affinity for Con A. The channel with Con A immobilized thereon was injected with 50 μl of yeast suspension at a flow rate of 100 nl/min. In both experiments, no binding of yeast occurred anywhere in the channel as predicted, and consequently no changes in current occurred either. This confirms that results shown in FIG. 4E (right) are due to specific binding.

The ability to selectively detect target cells in a complex mixture requires that non-specific binding of non-target cells onto the electrodes and the glass base between the electrodes be minimized. Given that non-specific interactions are weaker than specific binding events, non-specific interactions were minimized by using a flow rate high enough to unbind the non-specifically bound cells. In the 50 μm wide by 50 μm deep channels, at very low flow rates (below 100 nl/min), many non-target cells come to rest on the electrodes and the glass base of the channel. At flow rates higher than 200 nl/min, target cells did not have the opportunity to adsorb to the electrodes or the glass base of the channel, thus being undetectable using our technique.

A number of high-affinity monoclonal antibodies raised against bacterial surface antigens can also be used. The use of a mixture of such antibodies in the system maximizes specific interactions and further increases the strength of specific interactions relative to non-specific binding, further lower the possibilities for nonspecific adsorption.

### Example 9

### Small Channel Experiments

To further increase the electrical sensitivity of the sensor and also the probability of a cell being captured by the receptors in the active area, the 20 μm wide by 10 μm deep channels were used. In this experiment, no receptors were immobilized onto the electrodes, so all capture was a result of non-specific binding. FIG. 4F (left) shows cells being captured on the electrodes and clogging the channel. As shown in FIG. 4F (right), at t=20 secs as the first cells were captured by the electrode and the subsequent cells began accumulating in the channel, the impedance increased at a relatively steady rate. At t=160 secs, the fluid pressure was momentarily slightly increased to unbind the cells from the electrodes and unclog the channel, resulting in an instantaneous drop in impedance. Immediately after the drop, cells began re-accumulating, which resulted in a steady increase in impedance until t=220 secs when another momentary slight increase in fluid pressure was applied to release the cells. Beyond this time, no more cells were captured in the channel resulting in almost constant impedance over time.

For channel sizes comparable to the diameter of yeast (5 μm), nonspecific binding and channel clogging have been shown to be problematic. A channel depth of 10 μm has shown to be too shallow for optimal operation of the sensor. Larger channels have shown to be more practical, since they are sensitive enough to electrically detect the presence of a small number of cells, while at the same time minimizing channel clogging and nonspecific binding. However, to obtain an electrical sensitivity approaching the single cell level, an intermediate channel depth is preferred.

### Example 10

### Monitoring Protein-Protein Interactions

Both 10 μm latex beads and 10 μm CPG beads were covalently coated with lactoperoxidase. Lactoperoxidase has an affinity for binding to Con A which was used (at 10 mg/ml) as the probe molecule for immobilization onto the glass base in the micro-channel. The functionalized beads were suspended in Hepes buffer and then injected into the channel at a flow rate of less than 50 nl/min. A salt concentration of 200 mM KCl was used in this case to demonstrate the ability of this technique to work at high salt concentrations without degradation in performance. The electrical impedance was measured between electrodes 20, 40 (FIG. 5A). As a functionalized CPG beads became attached onto the electrode (FIG. 5B), the electrical impedance measured between electrodes A (20) and C (40) instantaneously increased (FIG. 5C).

### Example 11

### Monitoring Antigen-Antibody Interactions

The antigen-antibody interaction studies were performed using 9 μm diameter latex beads coated with hCG, a biomarker for pregnancy, and its determination is used for detection of early pregnancy. The microspheres functionalized with hCG were tested against the hCG antibody (diluted to 10 mg/ml), which was immobilized onto the base of the channel using physical adsorption.

### Example 12

### Binding Strength of Protein-Protein Interactions

Using the methods of the disclosure, it is possible to distinguish between specific protein-protein interactions and non-specific interactions based on the binding strengths. It is also possible to distinguish between various types of protein interactions. Typically the binding strength resulting from specific antigen-antibody interactions is stronger than that of non-specific interactions. The fluid flow rate in the channel is also directly proportional to the drag force being applied to the microsphere attached to the base of the channel. The drag force required to pull off the beads from the base of the channel is proportional to the binding strength of the proteins interacting with each other. This means that a larger binding force requires a higher flow rate to unbind the attached microspheres. Thus by measuring the flow rate required to detach the beads from the base of the channel for various interactions, it is possible to determine the binding strength relative to each other.

To examine the binding strength for antigen-antibody interactions and also glycoprotein-antigen interactions, the binding strengths holding the beads for various channel and bead surfaces were measured. Functionalized microspheres were incubated in the active region of the sensor until they came to rest at the glass base of the channel. The flow rate of the channel was incrementally increased until the microspheres became detached from the base of the channel. The mean flow rates required for dislodging all of the beads for the various assays and the corresponding standard error bars are shown in FIG. 5E.

Column A corresponds to the control experiment where polystyrene beads were functionalized with hCG and were incubated in a channel not bioactivated with any probe molecules. As a result, the beads were removed with a flow rate of 10 nl/min, demonstrating that the binding force between the beads and the surface is negligible.

Column B corresponds to the study of specific interactions between hCG and anti-hCG. Latex beads were functionalized with hCG and tested against a channel bioactivated with anti-hCG antibodies. The microspheres became detached as an average flow rate of 714 nl/min was applied. Binding strengths this large were expected due to the high affinity of specific antigen-antibody interactions.

Column C corresponds to the study of antigen-glycoprotein interactions. hCG functionalized latex beads were incubated in a channel bioactivated with Con A. Given that hCG is a glycoprotein in nature, it was interesting to measure its affinity with Con A compared to its specific interaction with anti-hCG antibody. An average flow rate of 300 nl/min was required to unbind the microspheres. While the affinity is significant, it was not as significant as that of column B, which confirms that specific antigen-antibody interactions are greater in strength than glycoprotein-glycoprotein interactions.

Column D corresponds to another control experiment, where plain latex beads were tested against a channel functionalized with anti-hCG antibody. A low flow rate of 33 nl/min was sufficient to dislodge the beads, confirming that the binding force between the beads and the surface is nonspecific and can therefore be neglected.

Column E corresponds to a third control experiment where latex beads functionalized with lactoperoxidase were tested against a bare channel surface. The binding strength holding down the beads was unexpectedly high, requiring an average flow rate of 560 nl/min to dislodge the beads. It is possible that this large affinity results from charge interactions between the glass and the lactoperoxidase. CPG beads coated with lactoperoxidase did not have the same non-specific binding issues that the polystyrene beads faced.

This phenomenon may be understood by analyzing the surface charge of the beads. The glass surface of the micro-channel and the CPG beads have an isoelectric point (pI) of 3.5, meaning that the surface charge is negative at the pH the system operates. The surface of the polystyrene beads however has a pI of 6.5, meaning that it is less negative compared to the CPG beads, almost neutral at the operating pH. Lactoperoxidase has a theoretical pI of 8.3, meaning that the surface charge is positive at the operating pH. Thus, the lactoperoxidase will result in the surface of the latex beads having an overall larger positive charge than the CPG, giving the polystyrene beads a greater affinity to the surface of the glass bead. By optimizing the surface chemistry taking into account the pI information to minimize the charge difference between the bead surface and the channel surface, nonspecific binding can be minimized. Nonspecific binding can be minimized using an appropriate blocking buffer.

### Example 13

### Microsphere Preparation

Anti-rabbit IgG, which has a specific affinity to anti-hCG antibody, was used as the primary receptor which was physically adsorbed onto 10 μm polystyrene beads (Bangs Labs, Wis.). The microspheres were suspended in 50 μl of PBS buffer at a concentration of 0.0118 g/ml. 10 μl of anti-rabbit IgG (5 μg/ml) was added to the bead solution, and rotated for 45 minutes to prevent precipitant from forming. The solution was then centrifuged, the supernatant was removed, and the beads were again resuspended in PBS. This process was repeated three times to ensure that all free antibodies were removed from the solution.

### Example 14

### Channel Surface Bioactivation

Anti-rabbit IgG was also used as the secondary receptor that was physically adsorbed onto the base of the microfluidic channel. Anti-rabbit IgG diluted in PBS solution to 5 μg/ml was injected into the channel and incubated for 15 minutes. The micro-channel surface was then coated with a blocking buffer, 1 mg/ml Bovine Serum Albinum (BSA) to minimize non-specific interactions. BSA solution was injected into the channel and incubated for 10 minutes.

### Example 15

### Anti-hCG Antibody Assay

For the test sample, PBS solution was spiked with various concentrations of anti-hCG antibody ranging from 10 μg/ml to 1 μg/ml. The functionalized beads were immersed in the test sample, and placed in a rotator for 45 minutes in order that the target protein in the test sample get captured by the microspheres. The solution was then centrifuged, the supernatant was removed, and then the beads were resuspended in PBS. This process was repeated three times to ensure that the free target protein molecules were removed completely from the solution.

The bead solution was injected into the micro-channel and incubated for 1 minute to allow the beads that captured the target protein biomarker to bind to the base of the channel forming a sandwich assay. A flow rate of 50 nl/min was then applied to the micro-channel to flush out the unbound beads. The number of beads before and after the washing was counted manually, and the electrical impedance was recorded simultaneously.

### Example 16

Referring to FIG. 5B, shown is an optical micrograph of electrodes 20 and 30 in a micro-channel 10 at t>5 secs after a lactoperoxidase coated CPG bead binds to electrode B 30. Electrode C 40 is not shown.

The hCG coated beads attached very well to the antibodies immobilized at the base of the channel. The electrical impedance was measured between electrodes A and C and similar results were obtained as the protein-protein interaction experiments (FIG. 5D). Microspheres passing between the electrodes without binding to the surface cause a transient increase in the current (at t=16 secs) and then a return to the original value after they leave the active area of the sensor. At t=27 secs, the peak corresponds to many beads passing across the sensor with only a fraction of them getting captured. The beads which are captured in the active area cause a permanent change in the measured resistance, as seen after t=27 secs.

### Example 17

Referring to FIG. 5E, in column A, the result of the control experiment is shown, where a hCG coated bead is tested against an untreated channel. In column B, hCG coated beads are tested against a channel with anti-hCG immobilized on the active area. The high flow rate demonstrates the high affinity resulting from specific antibody-antigen interactions. In column C, the glycoprotein properties of hCG are examined. hCG coated beads are tested against a channel with Con A immobilized on the surface. In column D, another control experiment is performed where a plain latex bead is tested against a surface which has anti-hCG immobilized on it. In column E, another control experiment is performed where beads covered with lactoperoxidase are tested against an untreated channel surface. The binding force in this case is unexpectedly high given that it is a non-specific interaction. In column F, beads coated with primary hCG antibodies are tested against a surface which is covered with secondary hCG antibodies and functionalized with hCG. The binding strength is large due to the nature of the specific binding.

### Example 18

### Microsphere Preparation

The target oligonucleotide of poly(dC)₁₀poly(dT)₅₂, 62 base pairs long, was biotinylated at the 5′ end. 1 μl of biotinylated target DNA (150 μM) was poured into 50 μl solution (PBS buffer) containing 0.5% (m/v) 20 μm polystyrened beads precoated with streptavidin (Spherotech Inc., Lake Forest, Ill.). The solution was rotated for 15 minutes to prevent precipitant from forming. The solution was then centrifuged, the supernatant removed, and the beads were again resuspended in PBS. The PBS buffer had a salt concentration of 700 mM NaCl that is required for rapid hybridization of DNA strands. This process was repeated three times to ensure that all free target DNA strands were removed from the solution.

### Example 19

### Immobilization of Probes on Channel Surface

The probe oligonucleotide of poly(dC)₁₀poly(dA)₅₂, 62 base pairs long, was biotinylated at the 5′ end. 15 μl of the biotinylated probe DNA (50 μM) was mixed with 1 μl of streptavidin (1 mg/ml) in PBS. The solution was then injected into the microfluidic channel and incubated to allow for the physical adsorption of the streptavidin with the glass base of the channel. Incubation times between 10-15 minutes produced the most optimal immobilization results.

### Example 20

### DNA Assay

The beads coated with target DNA were injected into the bioactivated micro-channel at a flow rate of less than 200 nl/min. As shown in FIG. 9B, the hybridization of the DNA strands causes the capture of a large bead. This results in an instantaneous increase in the channel resistance (FIG. 9C). After the first bead is captured onto electrode C, several beads pile up in the channel behind it. It is interesting that the hybridization of the two DNA strands was detected within seconds, compared to DNA microarrays which require incubation times as long as 24 hours.

### Example 21

### Minimizing False Positive Signals

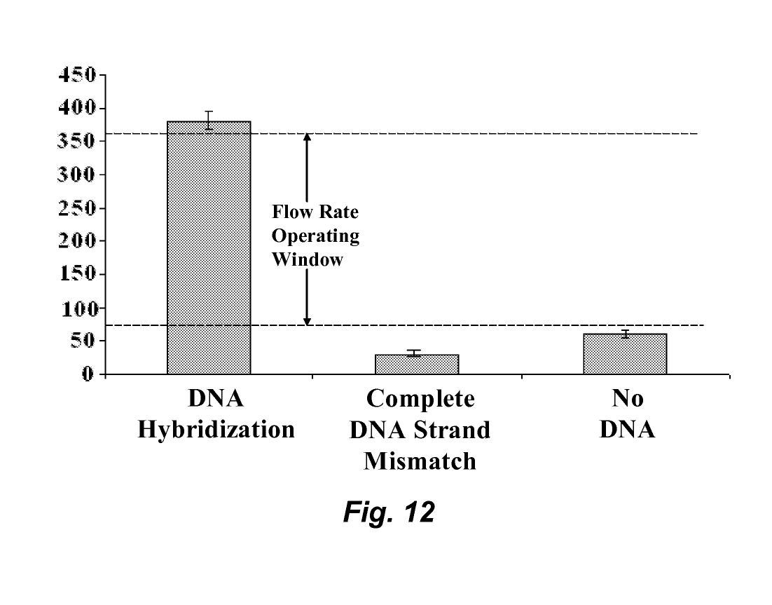

The beads for each assay were separately incubated in the channel for one minute. The flow rate was incrementally increased as the beads were pulled off. The average flow rates and the standard error required to detach the beads from the surface of the channel are shown in FIG. 12. In the first column the target DNA on the beads and the probe DNA on the channel surface were specific and complementary with each other, and were expected to hybridize. A flow rate of 370 nl/min was required to wash off the beads. In the second column, the target DNA and the probe DNA were completely mismatched, and the beads were washed off with a very negligible flow rate. In the third column neither the beads nor the channel surface contained any DNA and only contained streptavidin on their respective surfaces. The beads were removed with a flow rate of 50 nl/min. The beads and the channel surface with no target and probe DNA have a higher affinity with each other compared to the beads and the channel surface which have completely mismatched target and probe DNA. This can be explained by taking into account the charge interactions between the channel surface and the bead surface. In the case where the target and probe DNAs are mismatched, the DNA molecules are negatively charged due to the phosphate backbone of the DNA strands. This causes the DNA functionalized beads to be repelled from the channel surface which is coated with probe DNA. In the case where the glass surface of the channel has a pI of 2.5, meaning that it is negatively charged at the pH we are operating at (7.4). Streptavidin has a PI of 5 meaning that at the pH of operation (7.4) it is less negative, and so the repulsion force between the beads and the channel surface will be smaller.

DNA microarrays typically require overnight incubation before the hybridization can be detected. Using our biochip we are able to achieve detection of hybridization within seconds. The reason for this for this great decrease in analysis time is a result of the number of molecules required to hybridize before being detectable by the sensing apparatus. For DNA microarray technologies, at least several thousand molecules are required to hybridize before producing enough optical signal to be detected by the fluorescent scanners. In the case of our assay, this number can be determined by calculating the affinity of the beads to the surface of the micro-channel, and then determining the number of hybridized DNA molecules by dividing the total force by the force holding a single molecule together.

### Example 22

### Calculation of the Affinity of the Beads and the Channel Surface

The flow rate in the channel is directly proportional to the drag force applied to the beads. The drag force required to detach the beads from the surface of the channel is equal to the binding force between the hybridized DNA molecules. To determine the binding force between the hybridized DNA molecules accurately using the flow rates in FIG. 12, it would be necessary to perform a rigorous calculation of the relationship between the flow rate and the drag force on a sphere on the bottom of a micro-channel with the dimensions of our fabricated channels. However, to get a quick order of magnitude estimate of the drag force, it is possible to use the sphere-drag formula of Stokes:

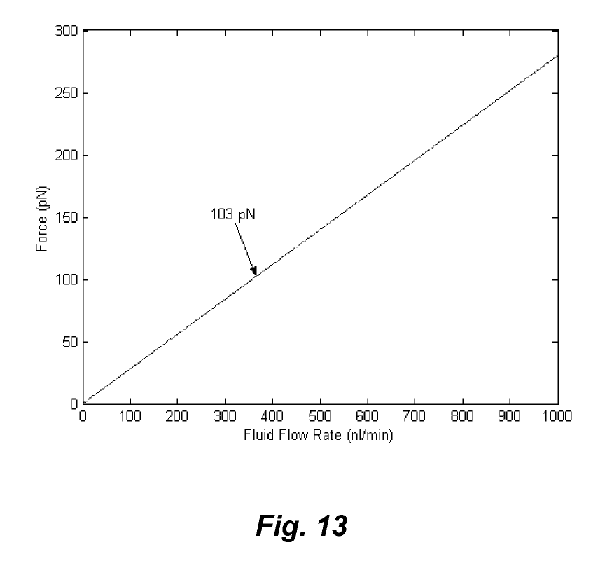

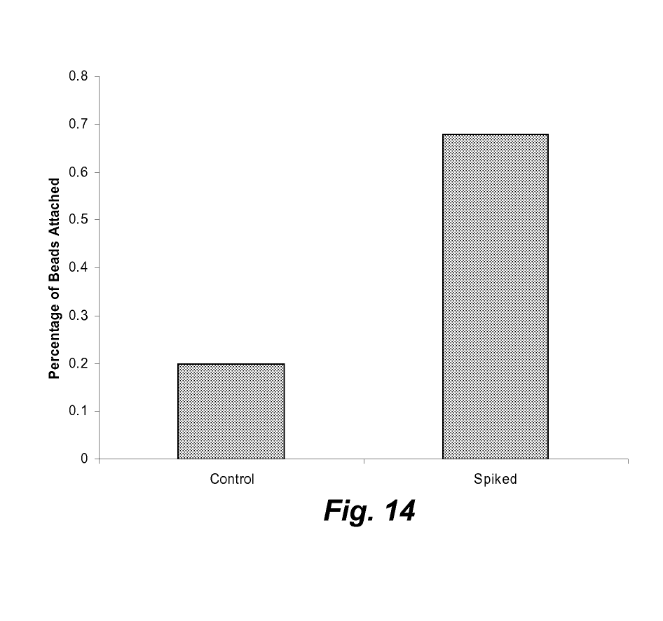

F=6πμUa (2)

where U is the mean velocity at which the sphere travels, and a is the radius of the sphere. Solving for equation 2 gives the results in FIG. 13.

An average flow rate of roughly 370 nl/min was required to pull the beads off the surface of the channel which corresponds to a drag force of 103 pN. The rupture forces for larger molecules of DNA tends to saturate at around 70 pN. This means that on average the beads are held attached to the base of the channel by the force of a single DNA molecule.

This confirmed the reason for the rapid hybridization detection rates as due to the fact that a single DNA molecule hybridizing is sufficient to cause the bead to get captured, compared to DNA microarrays which require several thousand DNA molecules to hybridize to generate enough optical signal to be detectable by the fluorescent scanners.

### Example 23

### Immunoassay with Biological Samples

Experiments were performed to demonstrate the ability of the system of the disclosure to detect the presence of a biological target, Carcinoembryonic Antigen (CEA), in human serum. Carcinoembryonic Antigen tends to present in the serum of healthy patients at levels below 100 pM, which is well above the lower detection limit of approximately 7 pM. The assay was performed with human serum spiked with exogenous CEA to a concentration of 1 μM, and also a separate control experiment without spiking the serum with CEA and which would, therefore, be present at normal levels.

Monoclonal anti-CEA antibodies were immobilized onto the beads, and polyclonal antibodies were then immobilized onto the surface of the microfluidic channel. The spiked serum resulted in almost 70% of the beads to remain attached, whereas the control experiment resulted in about 20% to remain attached. Based on data involving detection of anti-hCG in buffer, a 20% capture rate corresponded to approximately 10 pM, which is within the same order of magnitude as that would be expected of CEA quantity in a healthy patient.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include ±1%, ±2%, ±3%, ±4%, ±5%, ±6%, ±7%, ±8%, ±9%, or ±10%, or more of the numerical value(s) being modified. In addition, the phrase “about ‘x’ to ‘y’” includes “about ‘x’ to about ‘y’”.

It should be emphasized that the above-described embodiments of the present disclosure are merely possible examples of implementations, and are set forth only for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure.

We claim:

1. A method for detecting a target in a fluid comprising:
(a) determining a first electrical impedance of a first fluid disposed in a micro-channel;
(b) delivering to the micro-channel a test fluid suspected of comprising a target to be detected, wherein the target is a particulate target or a non-particulate target bound to a particle;
(c) washing the micro-channel with a second fluid, wherein the first and the second fluids have the same composition; and
(d) determining a second electrical impedance of the second fluid disposed in the micro-channel, whereby a difference between the first impedance and the second impedance indicates that a particulate target or a non-particulate target bound to a particle is present in the test fluid.

2. The method of claim 2, wherein the micro-channel comprises a surface having a first target-specific binding agent bound thereto, a first electrode, and a second electrode, wherein the first and second electrodes are configured to deliver an electrical current through a fluid disposed in the micro-channel.

3. The method of claim 2, wherein the first target-specific binding agent is selected from the group consisting of: a protein, a polypeptide, an oligonucleotide, a saccharide, a polysaccharide, and an antibody.

4. The method of claim 2, wherein the first target-specific binding agent is bound to a glass surface of the micro-channel.

5. The method of claim 2, wherein the micro-channel further comprises a third electrode disposed between the first electrode and the second electrode.

6. The method of claim 5, wherein the first target-specific binding agent is bound to a surface of the third electrode, disposed in the micro-channel.

7. The method of claim 1, wherein the particulate target is a cell selected from the group consisting of: an animal cell, a plant cell, a fungal cell, a protozoal cell, and a bacterial cell, and wherein the particulate target has a size sufficient to modify the impedance of the micro-channel when the target is bound thereto.

8. The method of claim 1, wherein the non-particulate target bound to a particle comprises a polymeric bead and a target ligand bound thereto, and wherein the target ligand is selected from the group consisting of: a protein, a polypeptide, an oligonucleotide, a saccharide, a polysaccharide, and an antibody.

9. The method of claim 8, wherein the particulate target further comprises a target molecule selectively bound to the ligand, and wherein the target molecule is capable of being selectively bound to the first target-specific binding agent in to the micro-channel.

10. A microfluidic device for detecting a target, comprising:
a micro-channel defined by a channel in a polymeric overlay, wherein the polymeric overlay is bonded to a substrate, and wherein the micro-channel is further defined by a surface of the substrate; and
a first electrode and a second electrode, wherein each of the first and the second electrodes extends into the micro-channel and are configured for passing of an electrical current through the micro-channel.

11. The microfluidic device of claim 10, further comprising a fluid entry port and a fluid exit port, the entry and exit ports each communicating with the micro-channel.

12. The microfluidic device of claim 10, further comprising a target-specific binding agent bound to the interior of the micro-channel.

13. The microfluidic device of claim 10, further comprising a third electrode disposed in the micro-channel and between the first electrode and the second electrode, wherein the target-specific binding agent is bound to the third electrode.

14. The microfluidic device of claim 10, wherein the first target-specific binding agent is selected from the group consisting of: a protein, a polypeptide, an oligonucleotide, a saccharide, a polysaccharide, and an antibody.

15. The microfluidic device of claim 10, wherein the first target-specific binding agent is bound to a glass surface of the micro-channel.

16. The microfluidic device of claim 10, further comprising a plurality of micro-channels, wherein each micro-channel is defined by a channel in an overlay bonded to a substrate, and further defined by a surface of the substrate, and each micro-channel further comprises a first electrode and a second electrode, wherein each of the first and the second electrodes extends into the micro-channel, and a device including a fluid entry port and a fluid exit port, the entry and exit ports each communicating with the plurality of micro-channels, and each the micro-channel.

17. The microfluidic device of claim 10, wherein the device further comprises an adjustable electrical power source, a signal amplifier, a computation system, and a display, and wherein the microfluidic device, the adjustable electrical power source, the signal amplifier, the computation system and the display are cooperatively linked to provide a measurement of the impedance through the micro-channel of the device.
